(19) United States
(12) Patent Application Publication
(10) Pub. No.: US 2021/0040354 A1
(43) Pub. Date: Feb. 11, 2021

(54) Reusable Adhesive Device

(71) Applicant: Maria Liliana Alarcon, Charlotte, NC (US)

(72) Inventor: Maria Liliana Alarcon, Charlotte, NC (US)

(21) Appl. No.: 16/943,310

(22) Filed: Jul. 30, 2020

Related U.S. Application Data
(60) Provisional application No. 62/884,227, filed on Aug. 8, 2019.

(51) Int. Cl. C09J 7/30; C09J 7/20; B65H 35/00

(52) U.S. Cl. CPC C09J 7/30; B65H 35/0026; C09J 7/20

(57) ABSTRACT

ppA reusable adhesive device is shown and described. The reusable adhesive device includes a first material having a first adhesive located on a bottom side. An indicium which represents a food is located on the opposite side of the first material from the adhesive. The reusable adhesive device is capable of being placed on a dispenser. The dispenser will secure the reusable adhesive device to the dispenser. The dispenser will allow a length of material to he cut from the reusable adhesive device for use.

### CROSS REFERENCE TO RELATED APPLICATIONS

This application claims the benefit of U.S. Provisional Application No. 62/884,227 filed on Aug. 8, 2019. The above identified patent application is herein incorporated by reference in its entirety to provide continuity of disclosure.

### BACKGROUND OF THE INVENTION

The present invention relates to a reusable adhesive device. More particularly, the present invention provides a device that can be used repeatedly to seal food items,

Currently, many different food items come in large packages. This means that the packages are opened and the contents are not finished. This leaves the individual with having to reseal the package. This often is unsuccessful leading to waste of the remaining food product.

In order to reseal containers, the containers are sometimes folded down. This only lasts for a short while. The containers often unfold allowing in oxygen or allowing food to fall from the container. Other times a clip is used to hold the container dosed. The clips tend to fall from the container allowing the container to open after a short while.

Consequently, there is a need for an improvement in the art of resealing food containers. The present invention substantially diverges in design elements from the known art while at the same time solves a problem many people face when attempting to successfully reseal food containers. In this regard the present invention substantially fulfills these needs.

### SUMMARY OF THE INVENTLON

The present invention provides a resealable adhesive device wherein the same can be utilized for providing convenience for the user when using a food container that needs to be resealed. The resealable adhesive device comprises a first material having an adhesive on a lower side of the first material. The adhesive will not lose its adhesive quality when removed and reused.

Another object of the resealable adhesive device is to provide a first material which has an indicium of food located thereon.

Another object of the resealable adhesive device is to provide a first material which has perforations located there across such that premeasured sections of the material may be torn away from the whole.

Another object of the resealable adhesive device is to provide a second material that is removably secured to the adhesive. The second material is removable to allow the adhesive to be used. wherein the second material is to be removed for use,

Another object of the resealable adhesive device is to provide a resealable adhesive device located about a roll.

Another object of the resealable adhesive device is to provide several roils of resealable adhesive devices secured together on a single roll.

Another object of the resealable adhesive device is to provide each roll of resealable adhesive devices have a different indicium located thereon.

Another object of the resealable adhesive device is to provide a dispensing device.

Another object of the resealable adhesive device is to provide a dispensing device that is comprised of a housing having a base with at least one sidewall rising therefrom. A dowel protruding from the at least one sidewall to removably secure the resealable adhesive device thereto. A front face secured to the base, wherein the upper edge of the front face contains a cutter to cut a piece of the resealable adhesive device.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FlG. 1 shows a perspective view of an embodiment of a roll of the resealable adhesive device.

FIG. 2 shows a perspective view of an embodiment of a roll of the resealable adhesive device with a removable backing.

FlG. 3 shows a perspective view of an embodiment of a dispenser for the roll of the reusable adhesive device.

FIG. 4 shows a perspective view of an embodiment of multiple rolls of the resealable adhesive devices secured together.

FlG. 5A shows a perspective view of an alternative embodiment of a stack of resealable adhesive devices in the shape of a carrot.

FIG. 5B shows a perspective view of an alternative embodiment of a stack of resealable adhesive devices in the shape of an apple.

### LIST OF REFERENCE NUMERALS

With regard to the reference numerals used, the following numbering is used throughout the drawings.
101 First material
102 Adhesive
103 Indicium
201 Second material
202 perforations
301 Base
Sidewall
303 Dowel
304 Front portion
305 Top portion
306 Cutter
501. Stack of devices
502 Apple
503 Carrot

### DETAILED DESCRIPTION OF THE INVENTION

Reference is made herein to the attached drawings. Like reference numerals are used throughout the drawings to depict like or similar elements of the resealable adhesive device. For the purposes of presenting a brief and dear description of the present invention, a preferred embodiment will he discussed as used for the resealable adhesive device. The figures are intended for representative purposes only and should not be considered to be limiting in any respect.

Referring now to FIG. 1, there is shown a perspective view of an embodiment of a roll of the resealable adhesive device. The resealable adhesive device includes a first material 101. The first material 101 is a strong flexible material. In one embodiment, the first material 101 is a plastic material. This will allow the first material 101 to prevent liquids from disintegrating the first material 101. In another embodiment, the first material 101 is made from another material.

An adhesive 102 is placed on the lower side of the first material 101. The adhesive 102 is a reusable adhesive. The adhesive 102 will not lose its adhesive qualities during repetitive use. This will allow for removal and re-adhering of the resealable adhesive device. This will allow for an individual to use the device multiple times without having to get a new section.

In some embodiments, the resealable adhesive device has an indicium 103 located on a top surface thereof. In different embodiments, the indicium 103 will represent food items. In the shown embodiment, vegetables are shown. In other embodiments, different foods are shown. In some embodiments non food items are displayed on the indicium 103. The indicium 103 is used to show potential items to be secured dosed by the device. The indicium are not to be limited by this disclosure and a large variety of indicium 103 may be used.

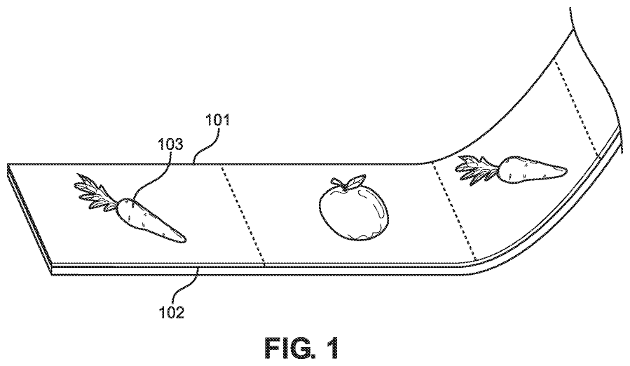

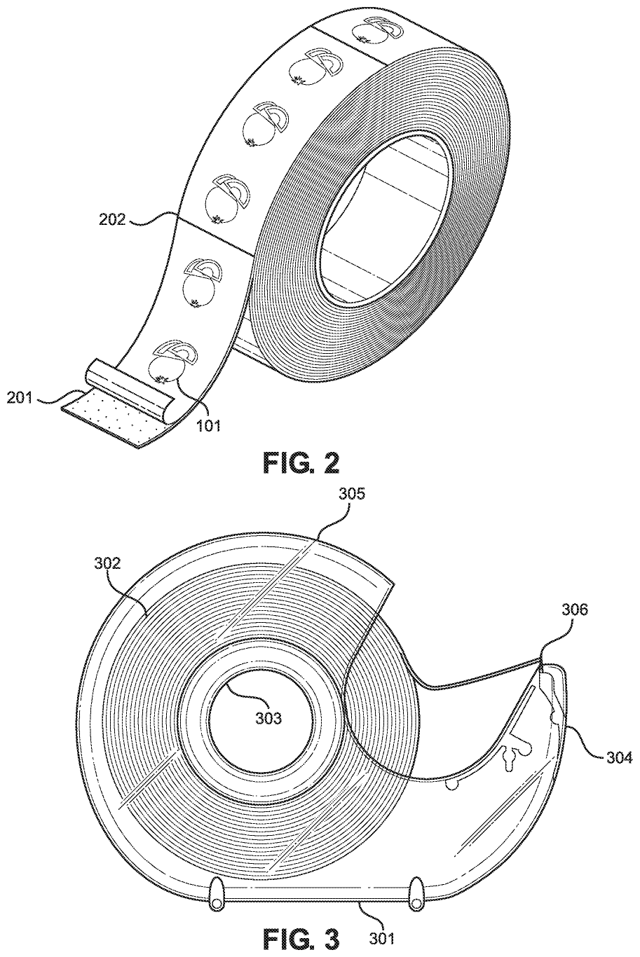

Referring now to FIG. 2, there is shown a perspective view of an embodiment of a roll of the resealable adhesive device with a removable backing. In one embodiment, the resealable adhesive device includes a second material 201. The second material 201 is a removable material. The second material 201 is removably secured to the adhesive on the bottom of the first material 101. This will prevent the device from sticking to unwanted items.

In different embodiments, the reusable adhesive device may be stored in different ways. in one embodiment, the device is stored folded together. In another embodiment, the device is stored in a ball. In the shown embodiment, the device is shown stored on a roll.

In one embodiment, the reusable adhesive device includes perforations 202.. in one embodiment, the perforations 202 are located at even intervals along the device. The perforations 202 will allow for a premeasured amount of the device to be torn from the entirety of the device for use. This will enable a user to easily tear the device.

Referring now to FIG. 3, there is shown a perspective view of an embodiment of a dispenser for the roll of the reusable adhesive device. In some embodiments, where the resealable adhesive device is stored on a roll, the roll may be placed within a dispenser. The dispenser is comprised of at least a base 301. In one embodiment, the base 301 is a planar base. This will allow the dispenser to rest on the base 301 on a flat surface. The dispenser further has at least one sidewall 302 rising from the base 301.

The at least one sidewall 302 has a dowel 303 protruding therefrom. The dowel 303 will allow a roll of the resealable adhesive device to be removably secured thereto. In one embodiment, the dowel 303 has at least one prong that will prevent the roll from unwantedly falling from the dowel 303. The at least one prong will be secured to the dowel 303 in a manner that allows the at least one prong to bend Into the dowel 303. This will allow a roll of reusable adhesive to be pushed over the at least one prong onto the dowel 303. The at least one prong will depress into he dowel 303 then reextend once the roll is in place securing the roll to the dowel.

The dispenser is further comprised of a front portion 304. The front portion 304 rises from the base 301 and is secured to the at least one sidewall 302. The front portion 304 is shorter than the at least one sidewall 302. This will ensure there is a gap in embodiments where the dispenser includes a top portion 305. The front portion 304 has a cutter 306 secured to the top of the front portion 304. In one embodiment the cutter 306 is a blade. In another embodiment the cutter is a plurality of sharp protrusions. The cutter 306 will allow for a user to cut a desired length of the reusable adhesive device from the whole for use by having the reusable adhesive device pressing into the cutter 306.

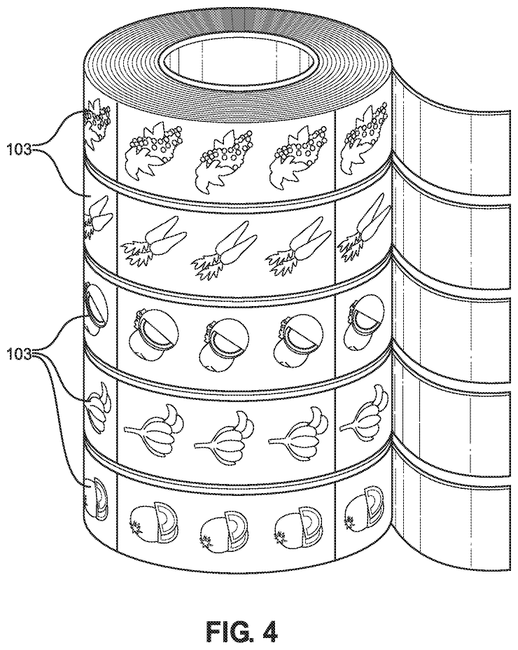

Referring now to FIG. 4, there is shown a perspective view of an embodiment of multiple rolls of the resealable adhesive devices secured together. In some embodiments, multiple rolls of the resealable adhesive device are secured together. This will allow for different indicia 103 to be placed on the front side of each different roll. The different indicia 103 could represent the food to be sealed with the device. In one embodiment, the different indicia 103 are used to represent different adhesives that are used. In one embodiment, one indicia 103 represents an adhesive that is meant to be use in a cold environment in another embodiment the indicia 103 is used to represent an adhesive that is meant to be used in a damp environment.

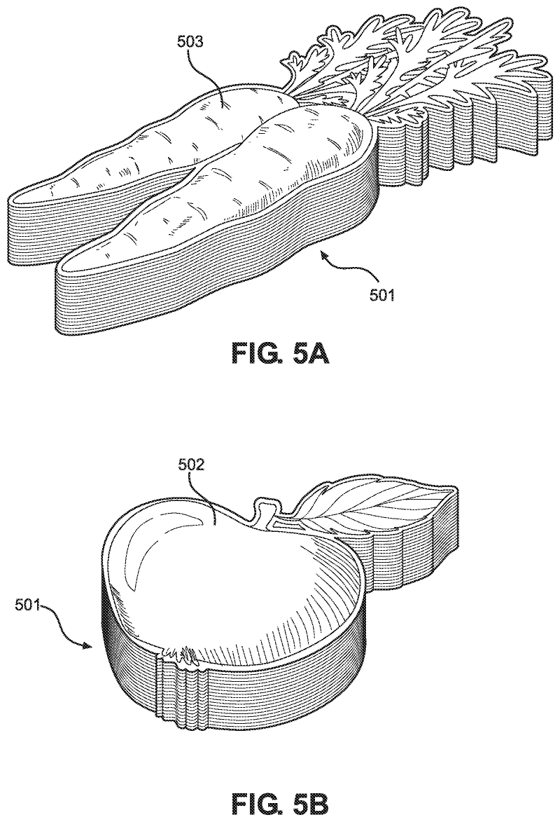

Referring now to FIG. 5A and FIG. 5B, there is shown a perspective views of an alternative embodiment of a stack of resealable adhesive devices in the shape of a carrot and an apple, respectively. in one embodiment, a plurality of resealable adhesive devices is stored in a stack 501. in one embodiment, the devices are held together via the adhesive. In another embodiment there is a second material which is removably secured to the adhesive. The second material will have a mild adhesive located on a side opposite the side stuck to the adhesive of the resealable adhesive device. The mild adhesive will hold the devices in a stack without leaving a residue on the next device. The mild adhesive will hold the devices in a roll or stack without letting them unfurl. However, it will still allow for only one device to be removed at a time. The regular adhesive has the potential to stick to the next device and potentially remove multiple devices unwantedly.

In one embodiment, the devices are in a standard geometric shape. In other embodiments, the devices are cut into the shapes of food. In the shown embodiments, the devices are cut into the shape of an apple 502 and a carrot 503 respectively, In other embodiments other shapes are used. The shapes are meant to be similar to the item represented by the stack 501, This disclosure is not intended to limit the types of shapes or items represented in any way.

it is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A resealable adhesive device, the device comprising:
a first material having an adhesive on a lower side of the first material;
wherein, the first adhesive does not loose adhesive quality when it is removed from a surface.

2) The resealable adhesive device of claim 1, wherein the first material has an indicium of food located thereon.

3) The resealable adhesive device of claim 1, wherein the first material has perforations located thereacross such that premeasured sections of the material may be torn away from the whole.

4) The resealable adhesive device of claim 1, further comprising a second material that is removably secured to the adhesive, wherein the second material is to be removed for use.

5) The resealable adhesive device of claim 1, wherein the resealable adhesive device is located about a roll.

6) The resealable adhesive device of claim 5, wherein several rolls of resealable adhesive devices are secured together.

7) The resealable adhesive device of claim 6, wherein each roll has a different indicium located thereon.

8) The resealable adhesive device of claim 1, further comprising a dispensing device.

9) The resealable adhesive device of claim 8, wherein the dispensing device is comprised of a housing having a base with at least one sidewall rising therefrom;
a dowel protruding from the at least one sidewall to removably secure the resealable adhesive device thereto;
a front face secured to the base, wherein the upper edge of the front face contains a cutter to cut a piece of the resealable adhesive device.

10) A resealable adhesive device, the device comprising:
a first material having an adhesive on a lower side of the first material;
wherein, the first adhesive does not loose adhesive quality when it is removed from a surface; and
wherein a plurality of resealable adhesive devices are removably stacked together.

11) The resealable adhesive device of claim 10, wherein the stack of resealable adhesive devices are in the shape of a food item.

12) The resealable adhesive device of claim 11, wherein the resealable adhesive devices are shaped like carrots.

13) The resealable adhesive device of claim 11, wherein the resealable adhesive devices are shaped like apples.

14) The resealable adhesive device of claim 10, further comprising a second material that is removably secured to the adhesive, wherein the second material is to be removed for use.

15) The resealable adhesive device of claim 10, wherein the first material has an indicium of food located thereon.
